(19) United States
(12) Patent Application Publication
(10) Pub. No.: US 2004/0184358 A1
(43) Pub. Date: Sep. 23, 2004

(54) Band link coupling pin, band, and wristwatch

(76) Inventors: Haruki Hiranuma, Chiba-shi (JP); Nobukazu Omori, Chiba-shi (JP)

Correspondence Address: ADAMS & WILKS, 31st Floor, 50 Broadway, New York, NY, 10004, US

(21) Appl. No.: 10/793,289

(22) Filed: Mar. 4, 2004

(30) Foreign Application Priority Data
Mar. 10, 2003 (JP) 2003-063254

(51) Int. Cl. G04B 37/00; F16G 13/08; F16G 13/06

(52) U.S. Cl. 368/282

(57) ABSTRACT

To provide a band link coupling pin capable of improving the operability of coupling and decoupling of any adjacent links, and capable of improving the reliability of coupling between the adjacent links. Provided is a link coupling pin in which a convex section (engagement section) including a second through hole is arranged in a concave section sandwiched by arm sections each including a first through hole to couple any adjacent links, and inserted into both first and second through holes. The coupling pin is made of a wire rod capable of changing in shape due to its elasticity to be smaller in diameter than the first and second through holes. At least one of each end section to be arranged in the first through hole of this pin and a middle part located in the second through hole forms an elastic deformation section being zigzag when viewed from the side. The elastic deformation section is so formed that the width at free state is made larger than the hole diameter of the first and second through holes, and at usage, is so formed as to elastically contact at least one hole inner plane of the first and second through holes.

### BACKGROUND OF THE INVENTION

1. Field of the Invention

The present invention relates to a band such as a bracelet or a watch band including a plurality of band links coupled to one another, a link coupling pin for coupling those plurality of links of the band, and a wristwatch provided with the above-described band.

2. Description of the Prior Art

Conventionally, for coupling respective links provided for a band of a wristwatch, so far proposed is an approach in which a through hole is formed in a coupling leg section each provided for any adjacent links to go through in the short direction of the band. Then, the coupling leg section belonging to one of the adjacent links is combined with the coupling leg section of the other link, and a coupling pin is inserted to the through holes opposing to each other in the short direction of the band. To both ends of this pin, a split pipe is fit to couple the adjacent links (refer to JP-A-7-313221 as an example).

In JP-A-7-313221, there is no description about the relationship between the split pipe and the links. In order to keep the coupling state among the links, however, it is considered that the split pipe is inserted into the through holes of the links for fixation not to be disconnected from the through holes, and this split pipe works to retain the coupling pin to prevent its accidental disconnection.

Also, in order to couple the links of the band of the wristwatch, so far proposed is another approach in which a through hole going through in the short direction of the band is each formed in arm sections sandwiching a concave section provided to one of any adjacent links and a convex section provided to the other link, and after combining the concave section and the convex section of the adjacent band links, a coupling pin looks like a hair pin is inserted into the through holes opposing in the short direction of the band. In this manner, the adjacent links are coupled together (refer to JP-A-10-80307 as an example).

The hair-pin-like coupling pin described in JP-A-10-80307 is formed by folding an elastic metal wire into two, and at a part thereof, toward the back, formed is an arc-shaped protrusion section protruding in the diameter direction.

Further, also described in JP-A-10-80307 is the technology of, for the purpose of preventing the coupling pin from dropping from the through holes due to varying diameters of the through holes, forming the protrusion section to be rectangular to allow it stand almost vertical with respect to the axial line of the coupling pin. Also, a stepped hole section to be placed in this protrusion section is formed at a part of the through hole of the convex section, so that the stepped hole section can function as a stopper by utilizing interference between the corner part of the protrusion section and the end part of the stepped hole section.

In JP-A-7-313221, the coupling pin and the split pipe used for retaining this pin not to drop are in plane contact. This requires rather large operation forces for relative attachment or removal of the coupling pin to/from the split pipe. Thus, to couple or decouple links to increase or decrease the number of links to match the wrist size of the human body, it is likely to require much time and effort to do so at shops.

In JP-A-10-80307, as to the one using the coupling pin with the rectangular protrusion section, the stepped hole section functioning as a stopper to prevent the coupling pin from moving in the axial direction may complicate removal of the coupling pin. Therefore, it may require much time and effort for decoupling at shops and others. What is worse, it also requires much time and effort to form the stepped hole section in the convex section of the link.

Moreover, with the structures of FIGS. 13 and 14 in JP-A-10-80307, fixation forces of the coupling pin to the through holes are derived by elastically compressing only two protrusion sections of the coupling pin to the inner planes of the through holes to abut. With such structures, it is easy to insert the coupling pin to the through holes. The problem here is that, when the fixation forces are reduced due to varying diameters of the through holes, the coupling pin sometimes moves in the longitudinal direction due to vibrations applied thereto at usage, and at the worst, disconnection may occur.

To improve such respects, the through holes may be increased in accuracy, and the coupling pin may be changed in shape to a greater degree. If this is the case, however, the processing cost for the through holes is surely increased, and the two-folded section of the coupling pin as a result of folding it into two may be deformed too much, and easily becomes vulnerable. As a result, if the coupling pins are once decoupled and used for reassembly (coupling of adjacent links), it may not exert the elastic rebound initially expected at designing, in other words, the initial quality is often not-retained.

An object of the present invention is to provide a band link coupling pin, a band, and a wristwatch with which the operability of coupling and decoupling of any adjacent links can be improved, and the reliability of coupling any adjacent links can be improved.

### SUMMARY OF THE INVENTION

In the present invention, provided is a band link coupling pin which is to be used for coupling any adjacent links through arrangement of an engagement section with a second through hole in a concave section that is sandwiched with arm sections each including a first through hole, and is to be inserted into both the first and second through holes. Then, in order to achieve the above object, the coupling pin of the present invention is made of a wire rod capable of changing in shape due to its elasticity to be smaller in diameter than the first and second through holes, and therein, at least either each end section to be arranged in the first through hole or a middle part to be arranged in the second through hole is regarded as an elastic deformation section looking zigzag when viewed from the side. This elastic deformation section is so formed that a width thereof at free state is larger than hole diameters of the first and second through holes, and when used, contacts a hole inner plane belonging to at least either the first or second through holes.

In the present invention and each invention in the below, as a wire rod capable of elastic deformation, a metal wire rod can be preferably used. In the present invention and each invention in the below, the expression of the elastic deformation section looking zigzag when viewed from the side-includes a helical or corrugated structure. When the elastic deformation section has a helical structure, to keep the contact length long with the hole inner plane, it is preferable to have at least one or more turns. Similarly, when the elastic deformation section has a corrugated structure, to keep four or more contacts with the hole inner plane, it is preferable to make it corrugated with one and a half pitch or more. Further, in the present invention and each invention in the below, the width of the elastic deformation section denotes, with the elastic deformation section viewed from the side direction, the dimension between components placed away with the maximum distance therebetween along the direction orthogonal to the axial direction of the coupling pin. To be specific, the width of the helical elastic deformation section is the outer diameter of the helical part, and the width of the corrugated elastic deformation section is the dimension of any two corrugated heads, one is oriented opposite to the other.

When any adjacent links are coupled to each other using the band link coupling pin of the present invention, the elastic deformation section of the coupling pin to be inserted into through holes is changed in shape due to its elasticity in such a manner as to be narrower in width than that at free state. Responding thereto, the coupling pin is entirely extended along the axial direction, whereby the elastic deformation section is not deformed too much. The elastic deformation section of thus inserted coupling pin comes into contact with the hole inner planes of the through holes due to its rebound force trying to return to its original shape, and thus this can solve the problem of the through holes varying in diameter. Further, because the elastic deformation section looks zigzag, the contact between the elastic deformation section and the hole inner planes of the through holes can be prevented from being too much. Also, because the elastic deformation section being zigzag elastically contacts the hole inner planes of the through holes, coupling between the adjacent links can be retained. Moreover, to release the coupling between the adjacent links, a rod tool may be pushed into the through holes to push out the coupling pin from the through holes. In this case, the zigzag elastic deformation section is not contacting too much the hole inner planes of the through holes as described in the foregoing, it causes less resistance to take out the pin from the through holes.

In a preferable embodiment of the band link coupling pin according to the present invention in which an elastic deformation section has a helical structure, the elastic deformation section comes into contact with the hole inner planes of the through holes in a helical manner. This can lengthen the contact length of the elastic deformation section to the hole inner planes of the through holes.

Moreover, in the present invention, provided is a band in which any adjacent links are coupled together by a coupling pin, through arrangement of an engagement section with a second through hole in a concave section that is sandwiched with arm sections each including a first through hole, being inserted into both the first and second through holes. Then, in order to achieve the above-described object, the coupling pin is made of a wire rod capable of changing in shape due to its elasticity to be smaller in diameter than the first and second through holes, and at least either each end section to be arranged in the first through hole or a middle part to be arranged in the second through hole is regarded as an elastic deformation section looking zigzag when viewed from the side. This elastic deformation section is so formed that a width thereof at free state is larger than hole diameters of the first and second through holes, and when used, contacts a hole inner plane belonging to at least either the first or second through holes.

In the present invention and each of other inventions, as to the expression of the adjacent links, one of those is provided with a concave section sandwiched with arm sections, and the other is provided with an engagement section to be arranged in the concave section for combination. In this case, the engagement section differs in form depending whether it is for relay or for non-relay. To be specific, when the main link with the concave section and another link for relay are adjacent to each other, both end sections of the link for relay are so formed in size as to be fit into the concave section of the main link to be placed on both sides of the band link for relay, and these end sections to be fit are used as engagement sections. Therefore, the main links are indirectly coupled to each other via the link for relay. On the other hand, in the case with the link for non-relay, one of the adjacent links is formed with a convex section that is to be used as an engagement section, and this convex section is fit into the concave section of the other link. As such, the adjacent links for non-relay are combined together. Further, the present invention is applicable to bands such as watch bands, bracelets, apparel bands, and necklace structured by a plurality of links, each of which is coupled to others.

The band of the present invention is structured by coupling links to each other via the coupling pin described in the foregoing. Thus, the operability of coupling and decoupling of any adjacent links can be improved, and the reliability of coupling adjacent links can be also improved.

In a preferable embodiment of the band of the present invention in which the elastic deformation section has a helical structure, the elastic deformation section of the coupling pin contacts the hole inner planes of the through holes in a helical manner. Thus, the contact length of the elastic deformation section with respect to the inner planes of the through holes can be kept long.

Further, to achieve the above object, the wristwatch of the present invention is provided with a watch body whose watch exterior assembly including a band-attachment section includes a watch movement, and a band according to the above-described invention coupled to the band-attachment section.

The wristwatch of the present invention is structured by coupling band links to each other via the coupling pin described in the foregoing. Thus, the operability of coupling and decoupling of adjacent links can be improved, and the reliability of coupling of adjacent links can be also improved.

### BRIEF DESCRIPTION OF THE SEVERAL VIEWS OF THE DRAWINGS

A preferred form of the present invention is illustrated in the accompanying drawings in which:

FIG. 1 is a plan view of a wristwatch according to a first embodiment of the present invention;

FIG. 2 is a plan view of a partially-cut-out band of the wristwatch of FIG. 1;

FIG. 3 is aside view of a link coupling pin of the wristwatch of FIG. 1;

FIG. 4 is a side view of a partially-cut-out band of a wristwatch according to a second embodiment of the present invention;

FIG. 5 is a side view of a link coupling pin of a wristwatch according to a third embodiment of the present invention; and

FIG. 6 is a plan view of a partially-cut-out band of a wristwatch according to a fourth embodiment of the present invention.

### DETAILED DESCRIPTION OF THE PREFERRED EMBODIMENTS

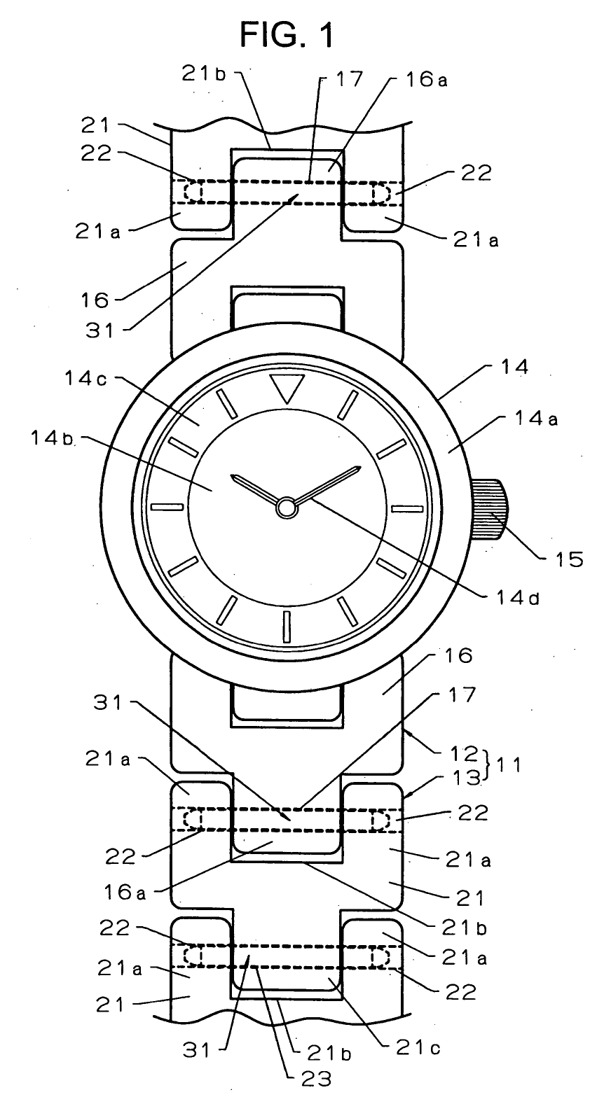

In the below, described is a first embodiment of the present invention referring to FIGS. 1 to 3.

A wristwatch denoted by a reference numeral 11 in FIG. 1 is provided with a watch body 12, and a watch band (hereinafter, simply referred to as band) 13.

The watch body 12 accommodates a watch movement, and the like, that are not shown in a watch exterior assembly 14 to be operated by a crown 15. The watch exterior assembly 14 is so formed that a cover glass 14b is attached over the surface of an annular case band 14a, and a case back (not shown) is attached over the back plane of the case band 14a. A dial 14c, hands 14d, and others provided inside can be seen through the cover glass 14b. The watch movement is not restrictive, and may be the one whose power source is a small-sized battery or a spring, the one of a self-winding type, the one equipped for a digital watch displaying time or others in digital form on a dial by quartz oscillator module, or the one as a result of combining the one equipped for a digital watch and the one equipped for others.

The watch body 12 is provided with a pair of band-attachment sections 16, which are used to sandwich the case band 14a from the directions of 12 o'clock and 6 o'clock. These band-attachment sections 16 each include, at their middle parts in the width direction, a convex section 16a protruding to the direction away from the case band 14a. Provided with the convex section 16a is a through hole 17 going through its width direction, in other words, the width direction (short direction) of the band 13.

The band 13 is so structured that a plurality of links 21 arranged in its extending direction are coupled together using a coupling pin 31.

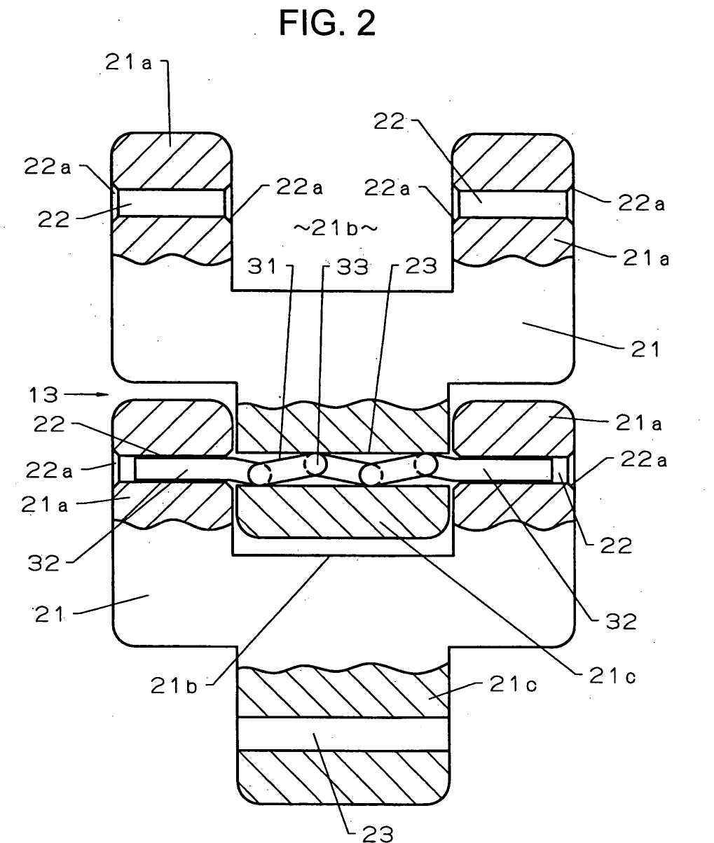

In detail, the links 21 are each made of metal, and all are the same components. These links 21 are each provided with, on one end side of their arrangement direction (in other words, the longitudinal direction of the band 13) as exemplarily shown in FIGS. 1 and 2, a pair of arm sections 21a, and a concave section 21b sandwiched by these arm sections 21a, and at the other end side of the arrangement direction, a convex section 21c functioning as an engagement section. The concave section 21b and the convex section 21c are located in the middle part of the link 21 in the width direction (width direction of the band 13). The convex section 21c is so made in size as to be fit to the concave section 21b.

Each of the pair of arm sections 21a is formed with a first through hole 22 going through in the width direction of the band 13. As mainly shown in FIG. 2, end sections of the opening of the first through hole 22 are each chamfered by an annular taper plane 22a. In each of the convex sections 21, a second through hole 23 is formed to go through in the width direction of the band 13. The hole diameter of the second through hole 23 is preferably equal to or larger than the hole diameter of the first through hole 22 to suppress snagging of the coupling pin 31 at the time of insertion, which will be described later. However, when end sections of the second through hole 23 are each chamfered by the annular taper plane, the hole diameter of the second through hole 23 can be equal to or smaller than the hole diameter of the first through hole 22. The first and second through holes 22 and 23 are not the stepped holes, and are straight holes showing substantially no change in diameter. Thus, the process required therefor is simple.

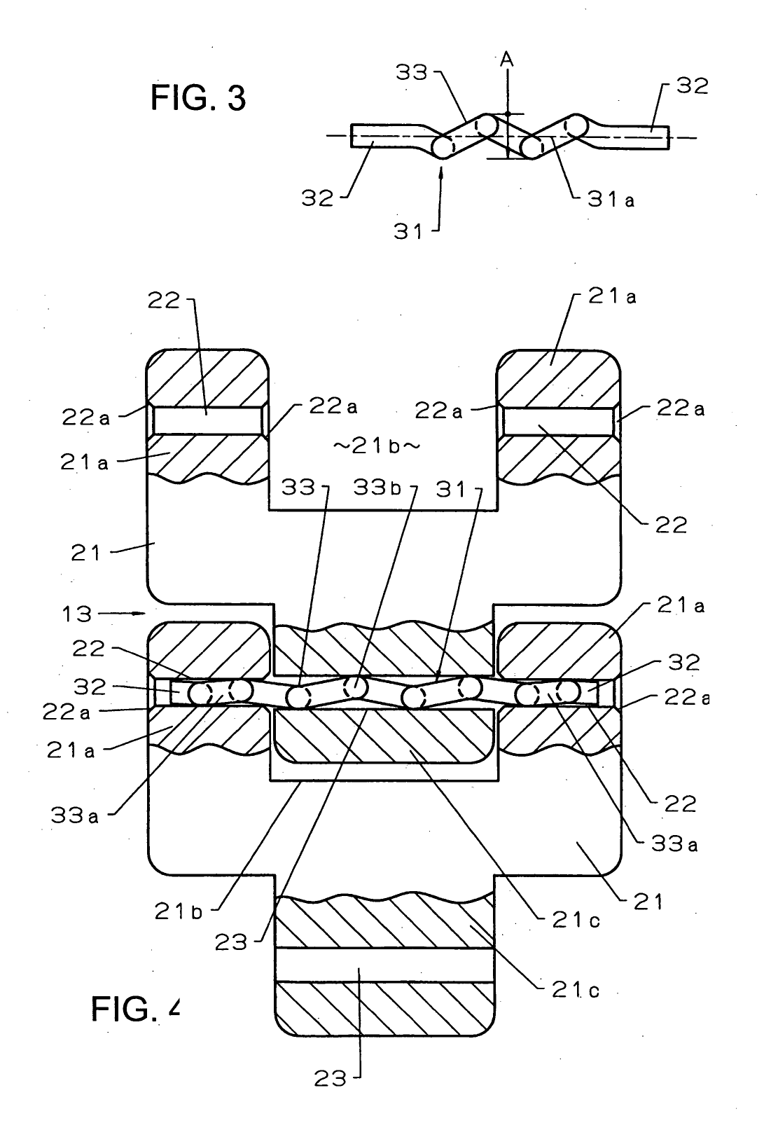

The coupling pin 31 is made of a circular rod made of an elastic metal wire to be smaller in diameter than the hole diameter of the first through hole 22. As exemplarily shown in FIGS. 2 and 3, the coupling pin 31 is formed by both-end sections 32 to be arranged in the first through hole 22, and by coupling those to be a piece, an elastic deformation section 33 to be arranged in the second through hole 23, for example. With the structure that will be described below, the elastic deformation section 33 functions as a coupling section with the link including a through hole into which this deformation section 33 is inserted.

As exemplarily shown in FIG. 3, the elastic deformation section 33 looks zigzag when the coupling pin 31 is viewed from the side direction (side view). Thus, in the first embodiment, the elastic deformation section is made helical (coil). Herein, the elastic deformation section 33 looking zigzag means that parts of the elastic deformation section 33 alternately intersect in the diagonal direction with respect to an axial line 31a of the coupling pin 31 in such a manner as if to draw a corrugation when viewed from the side.

This elastic deformation section 33 being helical is, for example, made from two turns. Further, the width A (refer to FIG. 3) when the elastic deformation section 33 is at free state is made lager than the hole diameters of the first through hole 22 and the second through hole 23.

Next, described is the procedure of assembling the band 13 by coupling any adjacent links 21 to each other using the coupling pin 31. First, the links 21 to be coupled are oriented in the same direction, and the concave section 21b of one of the links 21 is fit with the convex section 21c of the other link 21, and the links 21 are so positioned that the pair of first through holes 22 of above-mentioned one link 21 face to a single second through hole 23 of the other link 21. Under this state, the coupling pin 31 is inserted along its axial direction from one of the first through holes 22, and this pin 31 is inserted into the second through hole 23 and then to the other first through hole 22.

As such, by the coupling pin 31 inserted into the pair of first through holes 22 and the second through hole 23 located therebetween, the adjacent links 21 are coupled together as shown in FIG. 2. With such coupling, the both-end sections 32 of the coupling pin 31 are playably inserted into the first through hole 22, and thus the adjacent links 21 are allowed to rotate about the both-end sections 32 of the coupling pin 31.

At the time of insertion performed in the above manner, the elastic deformation section 33 of the coupling pin 31 is pressed by the hole inner planes of the first and second through holes 22 and 23, the diameters of which are both smaller than that of the elastic deformation section 33. Thus, the elastic deformation section 33 is changed in shape due to its elasticity as narrowing down the width A than that at free state, that is, as narrowing down in diameter in the first embodiment. Responding to such elastic deformation, the coupling pin 31 is extended in the axial direction in its entirety.

Such extension to this axial direction can prevent the contact forces of the elastic deformation section 33 to the hole inner planes of the first and second through holes 22 and 23 from increasing too much. Thus, insertion of the coupling pin 31 to the first and second through holes 22 and 23 can be done with rather light forces. Also, the elastic deformation section 33 is not deformed excessively to become vulnerable.

As a result, coupling between the adjacent links 21, that is, the assembly operation of the band 13 can be done with ease. What is better, in the first embodiment, the taper plane 22a is provided at the end sections of the opening of the first through hole 22. Thus, at the time of insertion performed in the above-described manner, this prevents the end sections of the elastic deformation section 33 locating at the head side at the time of insertion from being snagged on the arm sections 21a. In such a manner, the elastic deformation section 33 can be smoothly inserted into the first through hole 22, and also in this respect, the assembly operation can be done with ease.

After the coupling pin 31 is completely inserted as such, the elastic deformation section 33 elastically contact the hole inner planes of the second through holes 23 with the rebound force of the compressed elastic deformation section 33 trying to return to its originals shape. Thus, this solves the problem of varying diameters of the second through holes 23. What is better, the elastic deformation section 33 looking zigzag when viewed from the side does not contact, by plane, the hole inner planes of the second through holes 23 thanks to its shape, but contacts the same in a helical manner to keep the coupling among the adjacent links 21.

By such helical contact, compared with the conventional case using a coupling pin and a split pipe contacting by plane with this pin, the contact area is smaller. Accordingly, the resistance occurring when the coupling pin 31 is inserted is considerably smaller, and thus the coupling operation can be done with ease. Further, compared with the conventional case using a hair-pin-like coupling pin, derived is the helical contact much longer than the case with only two-point contact. Therefore, the coupling between the adjacent links 21 can be securely retained.

Note herein that, coupling between the band 13 assembled with the above-described procedure and the band-attachment section 16 of the watch body 12 is done also using the coupling pin 31. However, this procedure is the same as the above-described procedure of coupling the adjacent links 21 together using the coupling pin 31, and thus this is not described again. In this case, a through hole 17 of the band-attachment section 16 is used similarly to the second through hole 23 of the link 21.

Further, when coupling between the adjacent links 21 is released (decoupled) to shorten the band 13 in length at shops, for example, a rod tool (not shown) is pushed into one of the first through holes 22 to push out one of the both-end sections 32 of the coupling pin 31 to go outside of the band 13, and then the end section protruding to outside is picked up by the not-shown tool to pull out the coupling pin 31 in its entirety from the first and second through holes 22 and 23.

In this case, as described in the foregoing, the zigzag elastic deformation section 33 of the coupling pin 31 is helically contacting the hole inner planes of the second through hole 23. This contact is not too much contact as the case of plane contact resultantly causing press-fit, for example. Thus, the resistance at the time of pushing the coupling pin 31 from the second through hole 33 is small. Thus, with rather light forces, the coupling pin 31 can be taken out from the first and second through holes 22 and 23 for decoupling. As such, the band 13 can be adjusted in length with a rather short time at shops, and the like.

FIG. 4 shows a second embodiment of the present invention. The second embodiment is substantially the same in structure as the first embodiment, and thus any identical structure to that of the first embodiment is provided with the same reference numeral, and the structure and the effects are not described again. In the below, described are only the structures different therefrom.

In the second embodiment, over the coupling pin 31 in its almost entirety, formed is the elastic deformations section 33 being zigzag when viewed from the side, for example, being helical with four turns. Thereby, an end part coil section 33a locating closer to the both-end sections 32 is arranged in the first through hole 22 and elastically contacts the hole inner planes of this through hole 22. A middle coil section 33b between these end part coil sections 33a is located in the second through hole 23, and is elastically contacting the hole inner planes of this through hole 23.

The structures other than the above-described respects are the same as those of the first embodiment. Thus, also in this second embodiment, the object of the present invention can be achieved with the same effects as in the first embodiment. What is better, in the second embodiment, the elastic deformation section 33 of the coupling pin 31 are both elastically contacting the hole inner planes of the first and second through holes 22 and 23. With such a structure, the adjacent links 21 do not rotate as fast as before, but the elastic deformation section 33 contacts the hole inner planes to a greater degree. Accordingly, the coupling between the adjacent links 21 can be retained with more reliability.

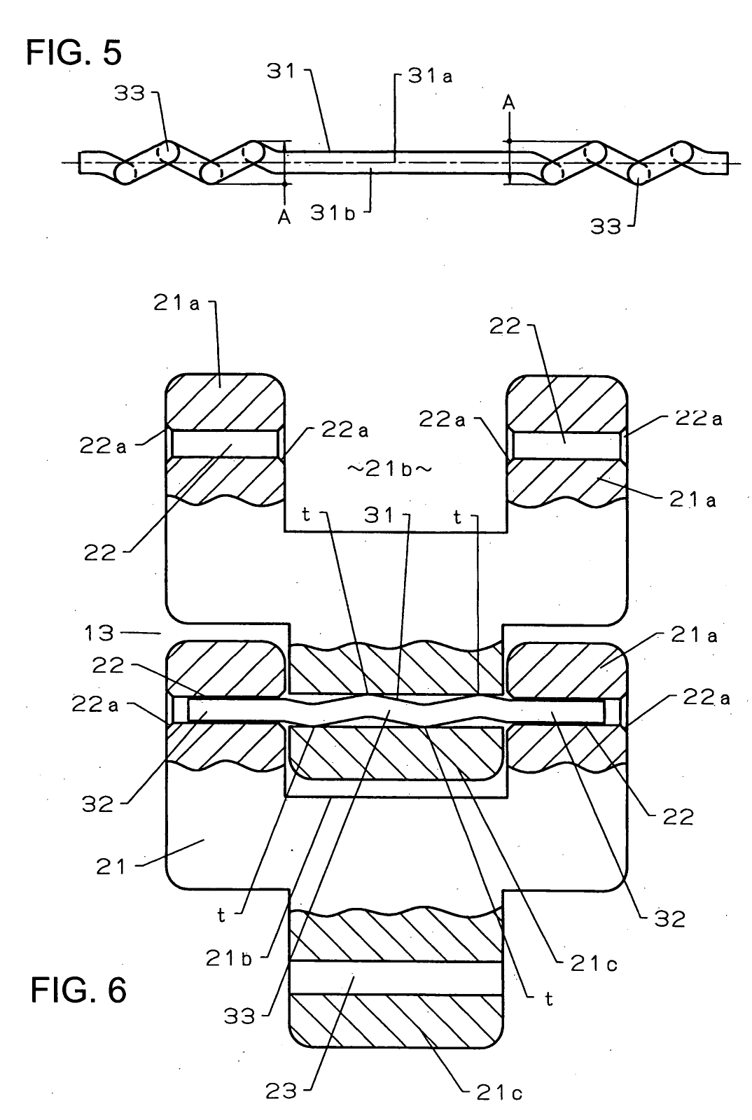

FIG. 5 shows a third embodiment of the present invention. The third embodiment is substantially the same in structure as the first embodiment, and thus any identical structure to that of the first embodiment is provided with the same reference numeral, and the structure and the effects are not described again. In the below, described are only the structures different therefrom. Herein, FIG. 2 is also referred to if needed.

In the third embodiment, both end sections of the coupling pin 31 form the zigzag, e.g., helical, elastic deformation section 33 when viewed from the side, and a middle part 31b therebetween is made to be straight. The elastic deformation section 33 of the end sections are located in a pair of first through holes 22, and are elastically contacting the hole inner planes of these through holes 22. The middle part 31b is arranged being playably inserted into the second through hole 23.

The structures other than those described above are the same as those of the first embodiment. Thus, also in this third embodiment, the object of the present invention can be achieved with the same effects as in the first embodiment. This third embodiment is considered preferable in the respect that, in a case where the band 13 is designed by narrowing the width of the convex section 21c of the link 21, the first through holes 22 of a pair of arm sections 21a and a pair of elastic deformation sections 33 to be arranged therein securely retain the coupling between the adjacent links 21.

FIG. 6 shows a fourth embodiment of the present invention. The fourth embodiment is substantially the same in structure as the first embodiment, and thus any identical structure to that of the first embodiment is provided with the same reference numeral, and the structure and the effects are not described again. In the below, described are only the structures different therefrom.

In the fourth embodiment, the elastic deformation section 33 looking zigzag when viewed from the side is formed by folding the middle part of the coupling pin 31 in a corrugated manner. In this case, the elastic deformation section 33 is made corrugated with about one and a half pitch or more. This elastic deformation section 33 is placed in the second through hole 23 of the link 21, and is elastically contacting the hole inner planes of the through hole 23 at several parts. When the corrugation is one and a half pitch, the inner planes of the second through hole 23 can be contacted by the elastic deformation section 33 at four parts in total all denoted by a reference character t in FIG. 6.

The structures other than the above respects are the same as the first embodiment. When the coupling pin 31 including the corrugated elastic deformation section 33 is inserted into the first through hole 22 and the second through hole 23, achieved is the insertion with extension in the axial direction in such a manner as if to increase the coil head angle. Thus, also in this fourth embodiment, the object of the present invention can be achieved with the same effects as in the first embodiment.

Here, this fourth embodiment can be performed by including the corrugated elastic deformation section 33 almost totally along the coupling pin 31. Alternatively, the corrugated elastic deformation section 33 may be provided only at both end sections to be arranged in the first through hole 22 of the coupling pin 31, and a middle part to be arranged in the second through hole 23 maybe set straight as if playably inserted into the second through hole 23.

According to a band link coupling pin, a band structured by coupling any adjacent links using this pin, and a wristwatch including this band of the present invention, the operability of coupling and decoupling of any adjacent links can be improved, and the reliability of coupling any adjacent links can be improved.

What is claimed is:

1. A band link coupling pin which is to be used for coupling adjacent links together through arrangement of an engagement section with a second through hole in a concave section that is sandwiched with arm sections each including a first through hole, and is to be inserted into both the first and second through holes, wherein
the coupling pin is made of a wire rod capable of changing in shape due to its elasticity to be smaller in diameter than the first and second through holes, and therein, at least either each end section to be arranged in the first through hole or a middle part to be arranged in the second through hole looks zigzag when viewed from the side, a width thereof at free state is larger than hole diameters of the first and second through holes, and when used, an elastic deformation section is formed to elastically contact a hole inner plane belonging to at least either the first or second through holes.

2. A band link coupling pin according to claim 1, wherein the elastic deformation section has a helical structure.

3. A band in which adjacent links are coupled together by a coupling pin, through arrangement of an engagement section with a second through hole in a concave section that is sandwiched with arm sections each including a first through hole, being inserted into both the first and second through holes, wherein
the coupling pin is made of a wire rod capable of changing in shape due to its elasticity to be smaller in diameter than the first and second through holes, and therein, at least either each end section to be arranged in the first through hole of this coupling pin or a middle part to be arranged in the second through hole looks zigzag when viewed from the side, a width thereof at free state is larger than hole diameters of the first and second through holes, and when used, an elastic deformation section is formed to elastically contact a hole inner plane belonging to at least either the first or second through holes.

4. The band according to claim 3, wherein the elastic deformation section has a helical structure.

5. A wristwatch, comprising:
a watch body in which a watch movement is included in a watch exterior assembly provided with a band-attachment section; and
the band, according to claim 3, coupled to the band-attachment section.

6. A wristwatch, comprising:
a watch body in which a watch movement is included in a watch exterior assembly provided with a band-attachment section; and
the band, according to claim 4, coupled to the band-attachment section.
